(19) United States
(12) Patent Application Publication
(10) Pub. No.: US 2024/0249117 A1
(43) Pub. Date: Jul. 25, 2024

(54) STATE CLASSIFICATION METHOD, STATE CLASSIFICATION DEVICE, AND STATE CLASSIFICATION PROGRAM

(71) Applicants: University Public Corporation Osaka, Osaka (JP); SEIKO EPSON CORPORATION, Tokyo (JP)

(72) Inventors: Masayoshi TODOROKIHARA, SUWA-SHI (JP); Keishi OMORI, MATSUMOTO-SHI (JP); Ryoya ONISHI, Osaka (JP); Michifumi YOSHIOKA, Osaka (JP); Katsufumi INOUE, Osaka (JP)

(73) Assignees: University Public Corporation Osaka, Osaka (JP); SEIKO EPSON CORPORATION, Tokyo (JP)

(21) Appl. No.: 18/415,578

(22) Filed: Jan. 17, 2024

(30) Foreign Application Priority Data
Jan. 20, 2023 (JP) 2023-007364

(51) Int. Cl. G06N 3/0455; G06N 3/0442

(52) U.S. Cl. CPC G06N 3/0455; G06N 3/0442

(57) ABSTRACT

A state classification method includes: acquiring measurement data of a physical quantity related to vibration measured for a vibrating device; outputting, by a deep learning model that includes an encoder and a decoder using a recurrent neural network and performs deep learning for predicting a future value of the measurement data for the device, an intermediate feature of the vibration from the encoder based on the measurement data; and classifying a state of the device using information based on the intermediate feature.

The present application is based on, and claims priority from JP Application Serial Number 2023-007364, filed Jan. 20, 2023, the disclosure of which is hereby incorporated by reference herein in its entirety.

### BACKGROUND

### 1. Technical Field

The present disclosure relates to a state classification method, a state classification device, and a state classification program.

### 2. Related Art

Failure diagnosis of a rotary machine used in a factory or the like is currently an important task. When a machine having a high degree of importance such as a machine serving as one end of a production line is stopped, a very large loss occurs. Since it is difficult to quickly stop a failure after the failure is diagnosed, it is important to find the failure earlier and diagnose a failure mode. The failure of the rotary machine includes many modes such as bearing damage, unbalance, and misalignment. Since influence of most failure modes appears in vibration, vibration data is often used for diagnosis.

In recent years, studies on failure diagnosis by vibration using deep learning have been conducted. According to deep learning, the need for specialized knowledge of machines for feature engineering is reduced. In addition, it is possible to more accurately grasp complicated vibration features related to vibration of a plurality of shafts. Currently, CNN-based methods provide excellent results in many abnormality diagnosis data sets. In order to handle time-series data such as vibration data by CNN, it is necessary to convert vibration into image information, and the vibration data is converted into a spectrogram by preprocessing by many methods. The spectrogram represents an intensity of a frequency component at each time in color information. For example, in a method of Tao, Hongfeng, et al. “An unsupervised fault diagnosis method for rolling bearing using STFT and generative neural networks”. Journal of the Franklin Institute 357.11 (2020): 7286-7307, vibration time-series data is converted into a spectrogram by short time Fourier transform and processed by the CNN, a GAN accompanied by clustering is used, and a failure class is clustered while unsupervised learning is performed by a generative basis.

Tao, Hongfeng, et al. “An unsupervised fault diagnosis method for rolling bearing using STFT and generative neural networks”. Journal of the Franklin Institute 357.11 (2020): 7286-7307 is an example of the related art and is hereinafter referred to as Tao, Hongfeng, et al.

### SUMMARY

In the method of Tao, Hongfeng, et al., the spectrogram is handled by the CNN, so that an intensity change in each frequency component of the vibration can be grasped. However, the CNN-based method using the spectrogram as an input cannot grasp a phase change in vibration. This is because only an amplitude intensity is reflected in the spectrogram, and phase information is deleted during conversion. Since it is considered that a failure of a machine appears as a change in the phase before the failure becomes apparent as a change in a vibration intensity, a change in an initial stage of the failure cannot be grasped by the CNN-based method.

A state classification method according to an aspect of the present disclosure includes:
acquiring measurement data of a physical quantity related to vibration measured for a vibrating device;
outputting, by a deep learning model that includes an encoder and a decoder using a recurrent neural network and performs deep learning for predicting a future value of the measurement data for the device, an intermediate feature of the vibration from the encoder based on the measurement data; and
classifying a state of the device using information based on the intermediate feature.

A state classification device according to an aspect of the present disclosure includes:
a measurement data acquisition unit configured to acquire measurement data of a physical quantity related to vibration measured for a vibrating device;
an intermediate feature output unit configured to output, by a deep learning model that includes an encoder and a decoder using a recurrent neural network and performs deep learning for predicting a future value of the measurement data for the device, an intermediate feature of the vibration from the encoder based on the measurement data; and
a state classification unit configured to classify a state of the device using information based on the intermediate feature.

A state classification program according to an aspect of the present disclosure causing a computer to:
acquire measurement data of a physical quantity related to vibration measured for a vibrating device;
output, by a deep learning model that includes an encoder and a decoder using a recurrent neural network and performs deep learning for predicting a future value of the measurement data for the device, an intermediate feature of the vibration from the encoder based on the measurement data; and
classify a state of the device using information based on the intermediate feature.

### BRIEF DESCRIPTION OF THE DRAWINGS

FIG. 1 is a diagram showing a forced vibration model of a system with one degree of freedom in a case of damping.

FIG. 2 is a flowchart showing a procedure of a state classification method according to an embodiment.

FIG. 3 is a schematic perspective view showing a configuration of a vacuum pump.

FIG. 4 is a diagram showing a configuration example of a state classification device that executes the state classification method according to the embodiment.

FIG. 5 is a diagram showing a configuration example of a deep learning model.

FIG. 6 is a diagram showing a configuration example of an encoder and a decoder.

FIG. 7 is a diagram showing a configuration example of an LSTM cell.

FIG. 8 is a diagram showing vectors to be orthogonalized.

FIG. 9 is a diagram showing assignment of washers of different classes in a rotor kit and label names thereof.

### DESCRIPTION OF EMBODIMENTS

Hereinafter, preferred embodiments of the present disclosure will be described in detail with reference to the drawings. The embodiments to be described below do not unduly limit contents of the present disclosure described in the claims. All configurations described below are not necessarily essential components of the present disclosure.

### 1. Consideration

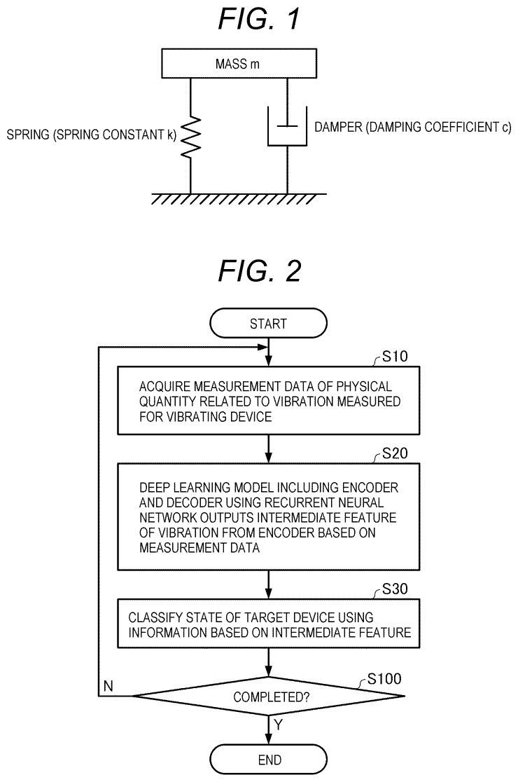

As shown in FIG. 1, a forced vibration model of a system with one degree of freedom in a case of damping is assumed, and a damping constant is calculated based on vibration phase information. A solution of a motion equation when a harmonic external force is applied to a mass m is given by a sum of a basic solution when the harmonic external force is set to be 0 and a special solution corresponding to the harmonic external force, and a behavior of a special solution may be considered for vibration in a steady state corresponding to the model shown in FIG. 1. The motion equation is expressed by Equation (1) in which ω is an angular frequency of the harmonic external force. In Equation (1), x is a displacement of the mass m, k is a spring constant, and c is a damping coefficient.

$$m \ddot{x} + c \dot{x} + k x = X sin ω t \qquad ( 1 )$$

A special solution of Equation (1) is expressed by Equation (2). φ is given by Equation (3), ωₙ is a resonance angular frequency of a system, and ζ is a damping constant.

$$x = X sin ( ω t - ϕ ) \qquad ( 2 )$$

$$ϕ = \frac{2 ζ ( \frac{ω}{{ω}_{n}} )}{1 - {( \frac{ω}{{ω}_{n}} )}^{2}} \qquad ( 3 )$$

When Equation (3) is solved for ζ, Equation (4) is obtained.

$$ζ = \frac{1 - {( \frac{ω}{{ω}_{n}} )}^{2}}{2 ( \frac{ω}{{ω}_{n}} )} tan ϕ \qquad ( 4 )$$

When an external force F is expressed in Equation (5), vibration in a steady state is given by a sum of corresponding special solutions as in Equation (6).

$$F = {A}_{1} sin ( ω t - {ϕ}_{10} ) + {A}_{2} sin ( 2 ω t - {ϕ}_{20} ) + … + {A}_{m} sin ( m ω t - {ϕ}_{m 0} ) + … \qquad ( 5 )$$

$$x = {A}_{1} sin ( ω t - {ϕ}_{1} - {ϕ}_{10} ) + {A}_{2} sin ( 2 ω t - {ϕ}_{2} - {ϕ}_{20} ) + … + {A}_{m} sin ( m ω t - {ϕ}_{m} - {ϕ}_{m 0} ) + … \qquad ( 6 )$$

In Equation (4), a relationship of Equation (7) is obtained by replacing φ with φₘ, replacing ω with mω, and replacing ζ with ζₘ.

$${ζ}_{m} = \frac{1 - {{m}^{2} ( \frac{ω}{{ω}_{n}} )}^{2}}{2 m ( \frac{ω}{{ω}_{n}} )} tan {ϕ}_{m} \qquad ( 7 )$$

When considering a special case where the external force F is known, if phases φₖ and φ₁ for two types of harmonic vibrations in a steady state are known, a relationship of Equation (8) is obtained by setting ζₖ=ζ₁ under an assumption that a frequency dependence of the damping constant ζ can be ignored. Since ω is known, ωₙ can be calculated from Equation (8), and the damping constant ζ can be calculated from Equation (7).

$$\frac{1 - {{k}^{2} ( \frac{ω}{{ω}_{n}} )}^{2}}{2 k} tan {ϕ}_{k} = \frac{1 - {{l}^{2} ( \frac{ω}{{ω}_{n}} )}^{2}}{2 l} tan {ϕ}_{l} \qquad ( 8 )$$

Generally, it is known that deterioration of components of a rotary device appears as a change in the spring constant k or the damping constant ζ before the deterioration becomes apparent as an increase in a vibration intensity. As described above, the damping constant ζ can be calculated by acquiring two or more phases for a plurality of vibration peaks corresponding to a fundamental wave and a harmonic wave. This suggests that a vibration phase includes information corresponding to a state of the rotary device, and phase information is useful for classification of a state of the rotary device. Here, in a state classification method according to the embodiment, a state of a device is classified by using time-series data measured for a vibrating device such as a rotary device as it is without converting the time-series data into information of a frequency domain such as a spectrogram.

### 2. State Classification Method

FIG. 2 is a flowchart showing a procedure of a state classification method according to the embodiment. The state classification method according to the embodiment is executed by, for example, a state classification device 100. A configuration example of the state classification device 100 that executes the state classification method according to the embodiment will be described later.

As shown in FIG. 2, first, in a step S10, the state classification device 100 acquires measurement data of a physical quantity related to the vibration measured for the vibrating device. The physical quantity is a physical quantity generated or changed by vibration.

A type of the vibrating device is not particularly limited, and the vibrating device may be various devices such as a motor having a rotary mechanism or a vibration mechanism, a structure such as a bridge or a building that vibrates due to an external force, or an electric circuit that generates a signal having periodicity. Types of the physical quantity related to the vibration are not particularly limited, and for example, first to N-th physical quantities may be an acceleration, an angular velocity, a velocity, a displacement, a pressure, a current, and a voltage. Hereinafter, the vibrating device that is a state classification target may be referred to as a “target device”.

The measurement data may be time-series data of a digital signal output from a sensor, or time-series data of a digital signal obtained by converting an analog signal output from the sensor by an analog front end. The measurement data may be measurement data of a plurality of channels. For example, the measurement data of the plurality of channels may be measurement data of physical quantities corresponding to an x-axis, a y-axis, and a z-axis orthogonal to one another. The sensor that outputs the measurement data may be, for example, a sensor using a quartz crystal vibrator, a sensor using a MEMS, or an IMU. The MEMS is an abbreviation for micro electro mechanical systems, and the IMU is an abbreviation for an inertial measurement unit.

The state classification device 100 may acquire measurement data measured by the sensor in real time, or may read and acquire measurement data measured in the past from a storage medium in which the measurement data is stored.

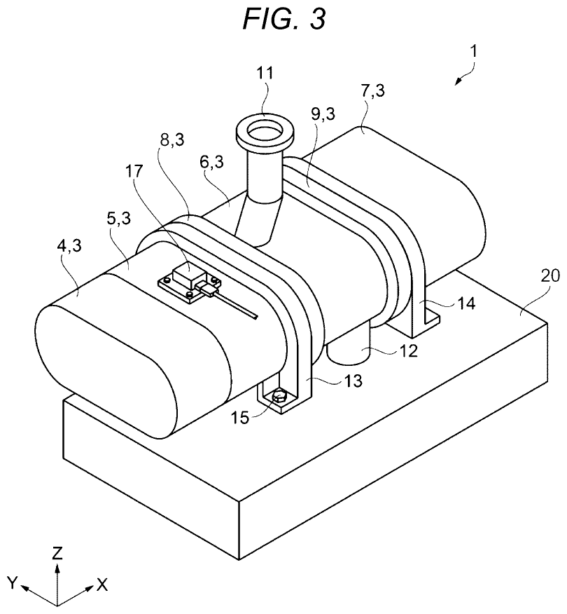

FIG. 3 shows a vacuum pump 1 as an example of the vibrating device. As shown in FIG. 3, the vacuum pump 1 is disposed on a base 20. The vacuum pump 1 has a columnar shape having a substantially long circle cross section. A longitudinal direction of the vacuum pump 1 is defined as an X direction. A long axis direction of the long circle is defined as a Y direction, and a short axis direction of the long circle is defined as a Z direction.

The vacuum pump 1 includes a housing 3. The housing 3 includes a motor case 4, a coupling portion 5, a pump case 6, and a gear case 7 disposed from a −X direction side toward a +X direction side. The housing 3 includes a first side wall 8 as a bearing casing between the coupling portion 5 and the pump case 6. The housing 3 includes a second side wall 9 between the pump case 6 and the gear case 7.

An intake pipe 11 is coupled to a surface of the pump case 6 on a +Z direction side. An exhaust pipe 12 is coupled to a surface of the pump case 6 on a −Z direction side.

The coupling portion 5 includes a first leg portion 13 and a second leg portion on the base 20 side. The first leg portion 13 is disposed on a −Y direction side, and the second leg portion is disposed on a +Y direction side. The gear case 7 includes a third leg portion 14 and a fourth leg portion on the base 20 side. The third leg portion 14 is disposed on the −Y direction side, and the fourth leg portion is disposed on the +Y direction side. The first leg portion 13 to the fourth leg portion are fastened to the base 20 by first bolts 15.

A sensor unit 17 is attached to the housing 3. The sensor unit 17 is attached to, for example, the coupling portion 5. For example, the sensor unit 17 is attached such that the x-axis direction, the y-axis direction, and the z-axis direction respectively coincide with the +X direction, the +Y direction, and the +Z direction. The sensor unit 17 outputs measurement data of three channels, that is, measurement data of three axes including the x-axis, the y-axis, and the z-axis. For example, the state classification device 100 acquires the measurement data of the three channels output from the sensor unit 17 in the step S10.

As shown in FIG. 2, next, in a step S20, the state classification device 100 outputs, by a deep learning model including an encoder and a decoder using a recurrent neural network, an intermediate feature of vibration from the encoder based on the measurement data acquired in the step S10. The deep learning model is a learning-completed model obtained by performing deep learning for predicting a future value of the measurement data for the target device. Details of the deep learning model will be described later.

Next, in a step S30, the state classification device 100 classifies a state of the target device using information based on the intermediate feature output from the deep learning model in the step S20. For example, the state classification device 100 may classify the state of the target device into a normal state or an abnormal state, or may classify the state into the normal state and any one of a plurality of types of abnormal states.

The state classification device 100 repeatedly performs the steps S10 to S30 until state classification processing is completed (N in step S100).

### 3. State Classification Device

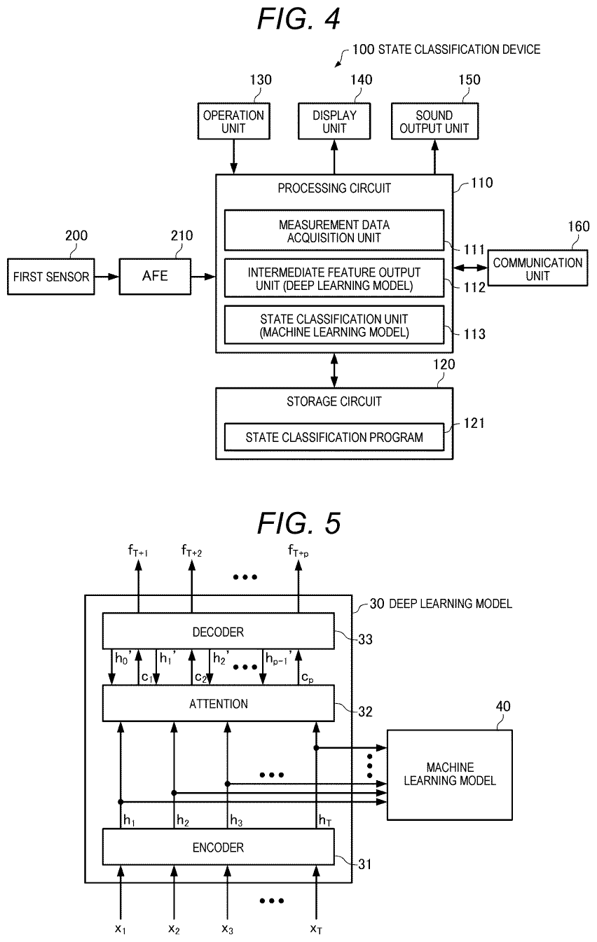

FIG. 4 is a diagram showing a configuration example of the state classification device 100 that executes the state classification method according to the embodiment. As shown in FIG. 4, the state classification device 100 includes a sensor 200, an analog front end 210, a processing circuit 110, a storage circuit 120, an operation unit 130, a display unit 140, a sound output unit 150, and a communication unit 160. The state classification device 100 may have a configuration in which a part of the components shown in FIG. 4 are omitted or changed, or other components are added. For example, the sensor 200 and the analog front end 210 may not be components of the state classification device 100.

The sensor 200 detects a physical quantity generated by vibration of the target device and outputs a signal corresponding to the detected physical quantity. An output signal of the sensor 200 is input to the analog front end 210.

The analog front end 210 performs amplification processing, A/D conversion processing, or the like on each output signal of the sensor 200, and outputs measurement data which is a digital time-series signal.

The processing circuit 110 acquires the digital time-series signal output from the analog front end 210 as the measurement data of the physical quantity related to the vibration of the target device, and performs processing of classifying the state of the target device. Specifically, the processing circuit 110 executes a state classification program 121 stored in the storage circuit 120 and executes various types of calculation processing on the measurement data. In addition, the processing circuit 110 executes various types of processing according to an operation signal from the operation unit 130, processing of transmitting a display signal for causing the display unit 140 to display various types of information, processing of transmitting a sound signal for causing the sound output unit 150 to generate various sounds, processing of controlling the communication unit 160 to perform data communication with an external device (not shown), or the like. The processing circuit 110 is implemented by, for example, a CPU or a DSP. The CPU is an abbreviation for a central processing unit, and the DSP is an abbreviation for a digital signal processor.

The sensor 200 may output the measurement data which is the digital time-series signal, and in this case, the processing circuit 110 may output the measurement data output from the sensor 200, and the analog front end 210 is not necessary.

The processing circuit 110 functions as a measurement data acquisition unit 111, an intermediate feature output unit 112, and a state classification unit 113 by executing the state classification program 121. That is, the state classification device 100 includes the measurement data acquisition unit 111, the intermediate feature output unit 112, and the state classification unit 113.

The measurement data acquisition unit 111 acquires the measurement data of the physical quantity related to the vibration measured for the vibrating device. N is a predetermined integer of 1 or more. That is, the measurement data acquisition unit 111 executes the step S10 in FIG. 2. The measurement data acquired by the measurement data acquisition unit 111 is stored in the storage circuit 120.

The intermediate feature output unit 112 is a deep learning model including an encoder and a decoder using a recurrent neural network, and outputs, based on the measurement data acquired in the step S10, an intermediate feature of vibration based on an output of the encoder. That is, the intermediate feature output unit 112 executes the step S20 in FIG. 2. The intermediate feature output by the intermediate feature output unit 112 is stored in the storage circuit 120.

The state classification unit 113 classifies the state of the target device based on the intermediate feature output from the intermediate feature output unit 112. That is, the state classification unit 113 executes the step S30 in FIG. 2. The state classification unit 113 may be a learning-completed machine learning model subjected to shallow machine learning. Information indicating the state of the target device classified by the state classification unit 113 is stored in the storage circuit 120.

As described above, the state classification program 121 is a program that causes the processing circuit 110, which is a computer, to execute the step S10, the step S20, and the step S30 in FIG. 2.

The storage circuit 120 includes a ROM and a RAM (not shown). The ROM is an abbreviation for a read only memory, and the RAM is an abbreviation for a random access memory. The ROM stores various programs such as the state classification program 121 and predetermined data, and the RAM stores data generated by the processing circuit 110. The RAM is also used as a work area of the processing circuit 110, and stores programs and data read from the ROM, data received from the operation unit 130, and data temporarily generated by the processing circuit 110.

The operation unit 130 is an input device including an operation key, a button switch, or the like, and outputs an operation signal corresponding to an operation of a user to the processing circuit 110.

The display unit 140 is a display device implemented by an LCD or the like, and displays various types of information based on a display signal output from the processing circuit 110. The LCD is an abbreviation for a liquid crystal display. The display unit 140 may be provided with a touch panel functioning as the operation unit 130. For example, the display unit 140 may display a screen including at least a part of various types of data stored in the storage circuit 120 based on a display signal output from the processing circuit 110.

The sound output unit 150 is implemented by a speaker or the like, and generates various sounds based on a sound signal output from the processing circuit 110. For example, the sound output unit 150 may generate a sound indicating the start or end of the state classification based on the sound signal output from the processing circuit 110.

The communication unit 160 performs various types of control for establishing data communication between the processing circuit 110 and an external device. For example, the communication unit 160 may transmit at least a part of various types of data stored in the storage circuit 120 to the external device, and the external device may display the received information on a display unit (not shown).

At least one of the measurement data acquisition unit 111, the intermediate feature output unit 112, and the state classification unit 113 may be implemented by dedicated hardware. The state classification device 100 may be a single device or may be implemented by a plurality of devices. For example, the sensor 200 and the analog front end 210 may be provided in a first device, and the processing circuit 110, the storage circuit 120, the operation unit 130, the display unit 140, the sound output unit 150, and the communication unit 160 may be provided in a second device separate from the first device. For example, the processing circuit 110 and the storage circuit 120 may be implemented by a device such as a cloud server, and the device may classify states of the target device and transmit information indicating the classified states to a terminal including the operation unit 130, the display unit 140, the sound output unit 150, and the communication unit 160 via a communication line.

### 4. Deep Learning Model

FIG. 5 is a diagram showing a configuration example of the deep learning model 30 functioning as the intermediate feature output unit 112. As shown in FIG. 5, the deep learning model 30 includes an encoder 31, an attention 32, and a decoder 33.

The encoder 31 is implemented using a recurrent neural network, and in an input step t, a measurement value xₜ included in the measurement data is input, an intermediate feature hₜ is output, and t is an integer of 1 to T, and corresponds to a time when the measurement value xₜ is measured. The measurement value xₜ is an m-dimensional vector including m elements. For example, when the measurement data is three-axis acceleration data, the measurement value xₜ is a three-dimensional vector. The intermediate feature hₜ is an n-dimensional vector including n elements. A total number T of measurement values and the integer n are set to be appropriate values by a creator of the deep learning model 30. In the embodiment, the recurrent neural network used for the encoder 31 is an LSTM. The LSTM is an abbreviation for a long short term memory.

The attention 32 weights and adds the intermediate features h₁ to h_{T} output from the encoder 31 in the input steps 1 to T by attention scores a_{i, 1} to a_{i, T} in a prediction step i, and creates a context vector cᵢ in the prediction step I, and i is an integer of 1 to p. The context vector cᵢ is an n-dimensional vector and is an input vector to the decoder 33 in the prediction step i.

The decoder 33 is implemented using a recurrent neural network, and in the prediction step i, the context vector cᵢ output from the attention 32 is input, and a prediction value f_{T+i} of the measurement data is output. The prediction value f_{T+i} is an m-dimensional vector including m elements. In the embodiment, the recurrent neural network used for the decoder 33 is an LSTM.

For example, the intermediate features h₁ to h_{T} are input to the machine learning model 40 functioning as the state classification unit 113, and the machine learning model 40 classifies the state of the target device using the intermediate features h₁ to h_{T}. The machine learning model 40 may be, for example, a support vector machine (SVM).

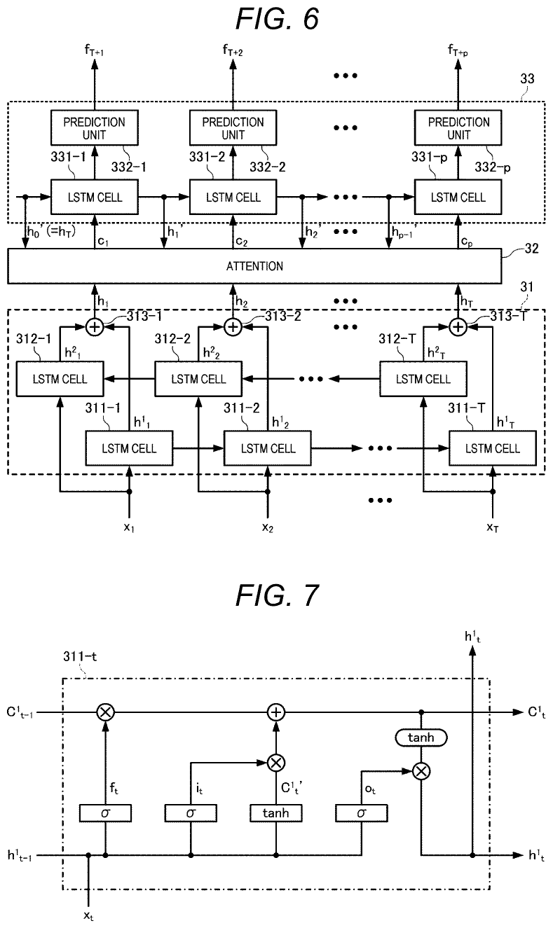

FIG. 6 is a diagram showing a configuration example of the encoder 31 and the decoder 33. As shown in FIG. 6, the encoder 31 includes T LSTM cells 311-1 to 311-T, T LSTM cells 312-1 to 312-T, and T adders 313-1 to 313-T.

The LSTM cell 311-t processes the measurement value xₜ and outputs a processing result to the LSTM cell 311-(t+1) at the subsequent stage, and t is an integer of 1 to T.

FIG. 7 is a diagram showing a configuration example of the LSTM cell 311-t. As shown in FIG. 7, the LSTM cell 311-t receives the measurement value xₜ, a cell state C¹ₜ₋₁ and a hidden state h¹ₜ₋₁ output from the LSTM cell 311-(t−1), and outputs a cell state C¹ₜ and a hidden state hit.

In FIG. 7, fₜ, iₜ, and oₜ are n+m-dimensional vectors calculated by Equation (9), Equation (10), and Equation (11) using a sigmoid function σ. Cₜ′ is an n+m-dimensional vector calculated by Equation (12) using a hyperbolic tangent function tanh. In Equation (9), Equation (10), Equation (11), and Equation (12), [h¹ₜ₋₁, xₜ] is an m+m-dimensional vector obtained by combining the hidden state h¹ₜ₋₁ which is an n-dimensional vector and the measurement value xₜ which is an m-dimensional vector. W_{f}, Wᵢ, Wₒ, and W_{c} are combination coefficients, and b_{f}, bᵢ, bₒ, and be are biases.

$${f}_{t} = σ ( {W}_{f} \cdot [ {h}_{t - 1}^{1} , {x}_{t} ] + {b}_{f} ) \qquad ( 9 )$$

$${i}_{t} = σ ( {W}_{t} \cdot [ {h}_{t - 1}^{1} , {x}_{t} ] + {b}_{i} ) \qquad ( 10 )$$

$${o}_{t} = σ ( {W}_{o} \cdot [ {h}_{t - 1}^{1} , {x}_{t} ] + {b}_{o} ) \qquad ( 11 )$$

$${C}_{t}^{{1}^{′}} = tanh ( {W}_{C} \cdot [ {h}_{t - 1}^{1} , {x}_{t} ] + {b}_{C} ) \qquad ( 12 )$$

The cell state C¹ₜ is calculated by Equation (13), and the hidden states hit is calculated by Equation (14). An operator “*” in Equation (13) means a Hadamard product, and an operator “*” in Equation (14) means a product of elements.

$${C}_{t}^{1} = {f}_{t} * {C}_{t - 1}^{1} + {i}_{t} * {C}_{t}^{{1}^{′}} \qquad ( 13 )$$

$${h}_{t}^{1} = {o}_{t} * tanh ( {C}_{t}^{1} ) \qquad ( 14 )$$

Returning to the description of FIG. 6, the LSTM cell 312-t processes the measurement value xₜ and outputs a processing result to the LSTM cell 312-(t−1) at the subsequent stage, and t is an integer of 1 to T. The LSTM cell 312-t is different from the LSTM cell 311-t in that a cell state C²ₜ₊₁ and a hidden state h²ₜ₊₁ output from the LSTM cell 312-(t+1) are input. That is, the LSTM cell 312-t receives the measurement value xₜ, the cell state C²ₜ₊₁ and the hidden state h²ₜ₊₁ output from the LSTM cell 312-(t+1), and outputs a cell state C²ₜ and a hidden state h²ₜ. Since a configuration of the LSTM cell 312-t is the same as that of FIG. 7, the description thereof will be omitted.

As shown in FIG. 6, the hidden state h¹ₜ output from the LSTM cell 311-t is input to the adder 313-t. The hidden state h²ₜ output from the LSTM cell 312-t is input to the adder 313-t. The hidden states h¹ₜ, h²ₜ are n-dimensional vectors including n elements. The adder 313-t adds up the hidden state h¹ₜ and the hidden state h²ₜ and outputs the intermediate feature hₜ. The intermediate feature hₜ is an n-dimensional vector including n elements.

As described above, in the encoder 31, a bidirectional LSTM including a forward direction LSTM corresponding to the LSTM cells 311-1 to 311-t and a reverse direction LSTM corresponding to the LSTM cells 312-1 to 312-t is used, and the adders 313-1 to 313-t add up an output of the forward direction LSTM and an output of the reverse direction LSTM at the same time. The intermediate features h₁ to h_{T} after the addition are subjected to orthogonalization described later. The bidirectional LSTM can extract features of the first half and the second half of the measurement data in a balanced manner. As a result of the deep learning, information extracted from the measurement data is aggregated in the intermediate features h₁ to h_{T}, and the machine learning model 40 classifies the state of the target device using the intermediate features h₁ to h_{T}.

In FIG. 6, the T LSTM cells 311-1 to 311-t that process the measurement values x₁ to x_{T} are shown in the encoder 31. Actually, one LSTM which is a recurrent neural network sequentially processes the measurement values x₁ to x_{T} received in the input steps 1 to T. Similarly, in FIG. 6, the T LSTM cells 312-1 to 312-t that process the measurement values x₁ to x_{T} are shown in the encoder 31. Actually, one LSTM which is a recurrent neural network sequentially processes the measurement values x_{T} to x₁ received in the input steps T to 1.

As shown in FIG. 6, the decoder 33 includes p LSTM cells 331-1 to 331-p and p prediction units 332-1 to 332-p.

The LSTM cell 331-i processes the context vector cᵢ output from the attention 32 and outputs a processing result to the LSTM cell 331-(i+1) at the subsequent stage, and i is an integer of 1 to p. The LSTM cell 331-1 receives the context vector cᵢ and a hidden state h₀′, and outputs a cell state C₁′ and a hidden state h₁′. The hidden state h₀′ is the intermediate feature h_{T}. The LSTM cell 331-i excluding the LSTM cell 331-1 receives the context vector cᵢ, a cell state Cᵢ₋₁′ and a hidden state hᵢ₋₁′ output from the LSTM cell 331-(i−1), and outputs a cell state Cᵢ′ and a hidden state hᵢ′. The cell state Cᵢ′ is an m-dimensional vector, and the hidden state hᵢ′ is an n-dimensional vector. Since a configuration of the LSTM cell 331-i is the same as that of FIG. 7, the description thereof will be omitted.

The context vector cᵢ output from the attention 32 is calculated by Expression (15). In Equation (15), α_{i, t} is an attention score to the input step t in the prediction step i, and is calculated by Equation (16). In Equation (16), e_{i, t} is calculated as an inner product of the hidden state hᵢ₋₁′ and the intermediate feature hₜ according to Equation (17). According to Equation (16) and Equation (17), the attention score α_{i, t} is larger as the hidden state hᵢ₋₁′ and the intermediate feature hₜ are approximate to each other. According to Expression (15), the attention score α_{i, t} is larger as a degree of contribution of the intermediate feature hₜ to the context vector cᵢ increases.

$${c}_{i} = {\sum }_{t = 1}^{T} {α}_{i , t} {h}_{t} \qquad ( 15 )$$

$${α}_{i , t} = \frac{exp ( {e}_{i , t} )}{{\sum }_{k = 1}^{T} exp ( {e}_{i , k} )} \qquad ( 16 )$$

$${e}_{i , t} = 〈 {h}_{i - 1}^{′} , {h}_{t} 〉 \qquad ( 17 )$$

The cell state Cᵢ′ output from the LSTM cell 331-i is input to the prediction unit 332-i, and an m-dimensional prediction value f_{T+i} is output from the prediction unit 332-i. For example, the prediction unit 332-i may convert the cell state Cᵢ′ into the prediction value f_{T+i} using a ReLU function. The ReLU is an abbreviation for a rectified linear unit.

The LSTM cell 311-t, the LSTM cell 312-t, and the LSTM cell 331-i are not limited to the configuration of FIG. 7, and various variations such as a configuration in which a cell state and a hidden state are merged may be considered.

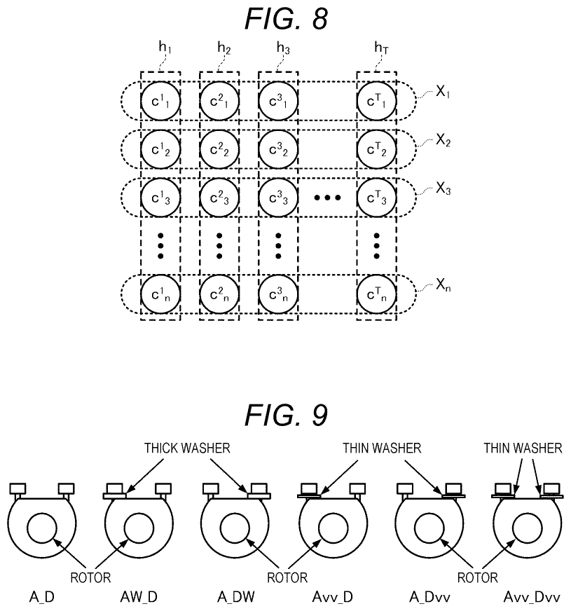

As described above, the deep learning model 30 is a learning-completed model obtained by performing the deep learning for predicting the future value of the measurement data for the target device. The intermediate features h₁ to h_{T} output from the encoder 31 include information related to the vibration of the target device. The information is information reflecting the state of the target device or time information independent of the state of the target device. Further, the information reflecting the state of the target device is considered to be independent for each failure mode. In general learning, various pieces of information related to the vibration of the target device are mixed in each element of the intermediate features h₁ to h_{T}, and further, independent information of the input vibration is distributed to a plurality of elements of the intermediate features h₁ to h_{T}. On the other hand, in the embodiment, the deep learning model 30 is caused to learn while applying orthogonalization pressure to the intermediate features h₁ to h_{T}. Specifically, as shown in FIG. 8, when the intermediate feature hₜ has n elements c^{t}₁, c^{t}₂, c^{t}₃, . . . , and c^{t}ₙ, a vector Xⱼ is defined by connecting the j-th elements c¹ⱼ, c²ⱼ, c³ⱼ, . . . , c^{T}ⱼ of the intermediate features h₁ to h_{T}, and the n vectors X₁ to Xₙ are orthogonalized, and j is an integer of 1 to n, and the element c^{t}ⱼ is the j-th element of the intermediate feature hₜ output at a time point t of the input. Specifically, the deep learning model 30 learns the n vectors X₁ to Xₙ such that non-diagonal components of a variance-covariance matrix Z expressed by Expression (18) approach 0, that is, a correlation between the vectors X₁ to Xₙ is small.

$$\sum = [ \begin{matrix}Var [ {X}_{1} ] & Cov [ {X}_{1} , {X}_{2} ] & … & Cov [ {X}_{1} , {X}_{n} ] \\ Cov [ {X}_{2} , {X}_{1} ] & Var [ {X}_{2} ] & & ⋮ \\ ⋮ & & ⋱ & ⋮ \\ Cov [ {X}_{n} , {X}_{1} ] & … & … & Var [ {X}_{n} ]\end{matrix} ] \qquad ( 18 )$$

It is easier to store independent information related to the vibration in a small number of different elements by the orthogonalization. Therefore, the intermediate features hᵢ to h_{T} in which an influence of confusion of different failure modes or vibration noise is reduced are obtained, and accuracy of the state classification of the target device by the machine learning model 40 can be improved.

A loss function L optimized during learning is expressed by Equation (19) by combining an orthogonalization loss Lₒᵣₜₕ and an MSE loss L_{pred}. The MSE is an abbreviation for a mean square error. In Equation (19), A is a hyper parameter for determining trade-off of the orthogonalization loss Lₒᵣₜₕ and the MSE loss L_{pred}. A combination coefficient W of the encoder 31 and the decoder 33 is learned in a direction in which the loss function L decreases.

$$L = {L}_{pred} + λ \cdot {L}_{o r t h} \qquad ( 19 )$$

The orthogonalization loss Lₒᵣₜₕ is expressed by Equation (20). The orthogonalization loss Lₒᵣₜₕ is a loss function defined such that orthogonalization proceeds among a plurality of elements c^{t}₁ to c^{t}ₙ included in the intermediate feature hₜ, and learning is performed in a direction in which the orthogonalization loss Lₒᵣₜₕ decreases. As a value of an autocorrelation of the plurality of elements c^{t}₁ to c^{t}ₙ increases, a value of the orthogonalization loss Lₒᵣₜₕ decreases. As a value of a cross-correlation of the plurality of elements c^{t}₁ to c^{t}ₙ decreases, the value of the orthogonalization loss Lₒᵣₜₕ decreases. In other words, by reducing the orthogonalization loss Lₒᵣₜₕ, an absolute value of each covariance Cov [Xᵢ, Xⱼ] expressing the autocorrelation decreases, and an absolute value of each variance Var [Xᵢ] expressing the cross-correlation increases. As a result, learning is performed such that temporal behaviors of the elements c^{t}₁ to c^{t}ₙ of the intermediate feature hₜ become independent.

$${L}_{o r t h} = \sum \vert Cov [ {X}_{i} , {X}_{j} ] \vert / \sum \vert Var [ {x}_{i} ] \vert \qquad ( 20 )$$

The MSE loss L_{pred} is expressed by Equation (21). In Equation (21), xᵢ is the i-th prediction value, and yᵢ is the i-th actual measurement value. The MSE loss L_{pred} is a loss function for predicting a future value of the measurement data, and the learning is performed in a direction in which the MSE loss L_{pred} decreases. By reducing the MSE loss L_{pred}, the future value can be accurately predicted, and useful information expressing the vibration state of the target device is extracted as the intermediate feature hₜ.

$${L}_{pred} = \frac{1}{n} {\sum }_{i = 1}^{n} {( {x}_{i} - {y}_{i} )}^{2} \qquad ( 21 )$$

The deep learning can be performed by unsupervised learning without requiring a label related to a failure. Since the encoder 31 and the decoder 33 are LSTMs, the time-series data can be input to the deep learning model 30 as it is. When the deep learning model 30 performs the deep learning before an operation of the target device, the target device is supposed to operate normally. Therefore, basically, normal time-series data is used as the time-series data of the physical quantity related to the vibration of the target device. When the deep learning model 30 is caused to perform learning using only the normal time-series data, the deep learning model 30 does not learn a pattern of abnormal time-series data. Therefore, information included in the intermediate features h₁ to h_{T} is greatly different between a case where the measurement data is normal and a case where the measurement data is abnormal, and the machine learning model 40 can classify whether the target device is in a normal state or an abnormal state.

On the other hand, when the deep learning model 30 performs the deep learning using not only the normal time-series data but also the abnormal time-series data, prediction accuracy of the deep learning model 30 is improved, and it is expected that useful information including an abnormal vibration state of the target device is extracted as the intermediate feature hₜ. Therefore, for example, the deep learning model 30 may perform learning using first time-series data of a physical quantity measured for a device in a normal state and second time-series data in which at least one of a phase and an amplitude of a signal component of a specific frequency of the first time-series data is changed. For example, the deep learning model 30 may perform learning using the first time-series data of the physical quantity measured for the device in the normal state and the second time-series data of the physical quantity measured for the device whose state changes with time after the first time-series data is measured. In any example, the first time-series data is normal time-series data, and the second time-series data is abnormal time-series data.

In the above description, the machine learning model 40 that is the state classification unit 113 classifies the state of the target device using the intermediate features h₁ to h_{T}, and may classify the state of the target device using context vectors c₁ to cₚ that are information based on the intermediate features h₁ to h_{T}.

### 5. Experimental Results

The inventors conducted experiments using a data set of vibration data obtained from two different devices, that is, a dry pump and a rotor kit, and verified validity of the method according to the embodiment. The inventors also created failure data, in which the phase is shifted by signal processing, as abnormal data in the data set of the dry pump. The inventors reproduced a change in state due to unbalance by changing a weight or the presence or absence of a weight fixed to a rotor in the data set of the rotor kit.

### 5-1. Experimental Results for Dry Pump

The dry pump to be measured is a dry pump AA70W manufactured by Ebara Corporation, and includes a main pump and a mechanical booster pump. Each pump includes a bearing and a gear. In order to measure vibration generated during operation of the dry pump, a six-axis digital output IMU sensor M-354 manufactured by Seiko Epson Corporation was fixed to an upper surface of the main pump such that a sensor X-axis was in an axial direction, a sensor Y-axis was in a left-right direction, and a sensor Z-axis was in an up-down direction. For the fixation, a strong adhesive thin double-sided tape confirmed to have no influence on the measurement was used. An UART was used as a communication protocol for acquiring data, and XYZ axis acceleration data and angular velocity data, and temperature data were acquired at 2000 samples per second for 5.5 seconds by dedicated logger software installed in a personal computer. In the verification of the validity of the method according to the embodiment, acceleration data among these pieces of data was used.

The inventors artificially created failure data by shifting a phase of an X-axis acceleration. Specifically, the inventors created failure data of three modes by shifting phases of frequency components of spectra of the measurement data having peaks at 85 Hz, 314 Hz, and 398 Hz. At the time of input to the deep learning model, each piece of data was cut out and used with a width of 64 points while being shifted by one point. Learning data and test data were divided at a ratio of 8:2 and used.

The deep learning model learned at a maximum of 2000 epochs using the learning data before the phase shift. The test data was input to the model after learning, and the obtained context vectors were classified by a classifier. Elements of the context vectors were input to the classifier one by one and then compared by the highest classification accuracy. The inventors evaluated a detection performance for data of each failure mode using a one-class SVM as the classifier. An AUC when a distance from a discrimination boundary of the one-class SVM was taken as a degree of abnormality was used as an evaluation index. Table 1 shows a result of the detection performance in a method of a comparative example without orthogonalization as the base and a method according to the embodiment with orthogonalization added to the base. As shown in Table 1, the method according to the embodiment exhibited an AUC higher than the method of the comparative example for all of the three failure modes. The AUC is an abbreviation for an area under the curve. From this result, it can be seen that information related to a failure is aggregated into a smaller number of elements by orthogonalization, and detection is facilitated.

TABLE 1

| | 85 Hz shift | 314 Hz shift | 398 Hz shift |
|---|---|---|---|
| Baseline | 0.572 ± 0.017 | 0.546 ± 0.008 | 0.551 ± 0.012 |
| Ours(+orthogo- | 0.579 ± 0.016 | 0.618 ± 0.018 | 0.586 ± 0.016 |
| nalization) | | | |

The inventors evaluated a classification performance among different failure modes by using the SVM as a classifier. Based on this evaluation, accuracy of estimating any one of the failure modes after failure detection is compared. Table 2 shows the classification accuracy among the failure modes in the method of the comparative example without orthogonalization as the base and the method according to the embodiment with orthogonalization added to the base. As shown in Table 2, according to the method of the embodiment, the classification accuracy of the failure data obtained by shifting the 85 Hz component and the failure data obtained by shifting the 314 Hz component, and the classification accuracy of the failure data obtained by shifting the 314 Hz component and the failure data obtained by shifting the 398 Hz component were greatly improved. From these results, it is considered that the aggregation of the information of the respective failure modes into different elements by the orthogonalization contributes to the improvement of the accuracy. Although the classification accuracy of the failure data obtained by shifting the 85 Hz component and the failure data obtained by shifting the 398 Hz component is lower than that of the method according to the comparative example, it is considered that this is because the pieces of information related to the respective failures are aggregated into the same element.

TABLE 2

| | 85 Hz/314 Hz | 314 Hz/398 Hz | 85 Hz/398 Hz |
|---|---|---|---|
| Baseline | 66.5 ± 3.6⁰₀ | 59.0 ± 3.0⁰₀ | 64.6 ± 4.0⁰₀ |
| Ours(+orthogo- | 78.5 ± 2.8⁰₀ | 80.2 ± 1.8⁰₀ | 56.9 ± 1.1⁰₀ |
| nalization) | | | |

### 5-2. Experimental Results for Rotor Kit

In order to perform verification using labeled actual data, the inventors collected data using small-sized rolling bearing rotor kits AA31-020 manufactured by Shinkawa Electric Co., Ltd as measurement targets. A three-axis digital output vibration sensor M-A342 manufactured by Seiko Epson Corporation was fixed to an upper surface of a bearing such that a sensor Y-axis was in an axial direction, a sensor X-axis was in a left-right direction, and a sensor Z-axis was in an up-down direction. The vibration sensor was developed for a purpose of measuring vibration of a rotary device. By a configuration in which a one-axis vibration sensor having the same characteristics is mounted on three axes to perform digital signal processing, a flat frequency response characteristic in a use band of 10 Hz to 1000 Hz and excellent synchronization accuracy of 10 μs or less during acquirement of three-axis data are implemented. The vibration sensor has a feature that the vibration sensor is less likely to be affected by induction noise or the like by minimizing an arrangement of an analog wiring.

In order to fix the sensor, a strong adhesive thin double-sided tape confirmed to have no influence on the measurement was used. A UART was used as a communication protocol for acquiring data, and XYZ axis velocity data and temperature data were acquired at 3000 samples per second by dedicated logger software installed in a personal computer. For a purpose of detecting and classifying a change in vibration due to a slight change in unbalance, for components fixed to a rotor, the rotor, in which the presence or absence of two types of washers, that is, a thick washer and a thin washer changes, was rotated at 1200 rpm, and data in which respective fixed states were used as labels was used for verification. Six classes of data having different rotor states depending on the presence or absence of the washer were prepared. FIG. 9 shows assignment of washers of different classes and label names thereof. FIG. 9 is a diagram of the rotor and the components fixed to the rotor as viewed from a direction of a rotation axis of the rotor.

The inventors confirm that there is no significant difference in vibration RMS value depending on the presence or absence of the washer in the classes. At the time of input to the deep learning model, each piece of data was cut out and used with a width of 64 points while being shifted by 32 points. Learning data and test data were divided at a ratio of 3:1 and used.

The deep learning model learned at a maximum of 500 epochs using learning data of all classes. The inventors input the test data to a model after learning, and evaluated a separation performance between the classes using the obtained context vector. A silhouette coefficient was used as an index for the evaluation. The silhouette coefficient reflects a distance between classes and an aggregation degree between classes, and indicates a larger value as the separation performance is higher. The silhouette coefficient when each element of the context vector was used was calculated and then compared by the highest value. Table 3 shows silhouette coefficients when the method of the comparative example as a base line is used. Table 4 shows silhouette coefficients when the method of the embodiment is used. In Tables 3 and 4, the silhouette coefficients between the two classes are shown in all combinations. An average of the silhouette coefficients in all the combinations was 0.9071 in the method of the comparative example, and 0.9239 in the method of the embodiment. The method of the embodiment was superior to the method of the comparative example. From Tables 3 and 4, there is a tendency that the method of the embodiment is excellent when the change in state is small, that is, when a thin washer is attached.

TABLE 3

| | A D | AW D | A DW | A Dvv | Avv D | Avv Dvv |
|---|---|---|---|---|---|---|
| A D | — | 0.9537 | 0.9680 | 0.9348 | 0.9141 | 0.9299 |
| AW D | — | — | 0.9568 | 0.9132 | 0.8720 | 0.8704 |
| A DW | — | — | — | 0.9483 | 0.9381 | 0.9247 |
| A Dvv | — | — | — | — | 0.8584 | 0.7755 |
| Avv D | — | — | — | — | — | 0.8494 |
| Avv Dvv | — | — | — | — | — | — |

TABLE 4

| | A D | AW D | A DW | A Dvv | Avv D | Avv Dvv |
|---|---|---|---|---|---|---|
| A D | — | 0.9432 | 0.9587 | 0.9359 | 0.9289 | 0.9491 |
| AW D | — | — | 0.9409 | 0.9297 | 0.9145 | 0.9049 |
| A DW | — | — | — | 0.9482 | 0.9555 | 0.9327 |
| A Dvv | — | — | — | — | 0.9116 | 0.8270 |
| Avv D | — | — | — | — | — | 0.8783 |
| Avv Dvv | — | — | — | — | — | — |

### 6. Operation and Effect

According to the state classification method of the embodiment described above, since the deep learning model 30 includes the encoder 31 and the decoder 33 using the recurrent neural network, the measurement data can be used for learning as time-series data. That is, it is possible to use the time-series data storing the phase information as it is for learning without converting the measurement data into a frequency spectrum or a spectrogram in which the phase information is missing. Therefore, the intermediate features h₁ to h_{T} output from the encoder 31 of the deep learning model 30 also include the phase information of the vibration of the target device. Therefore, according to the state classification method of the embodiment, the machine learning model 40 can more accurately classify the state of the target device by using the information based on the intermediate features h₁ to h_{T} to grasp a phase change of the vibration of the target device that cannot be detected by the RMS value of the frequency spectrum or the spectrogram.

According to the state classification method of the embodiment, by using the measurement data of the plurality of channels, the phase information included in the measurement data is relatively increased, and the phase change of the vibration of the target device is easily grasped, and thus the state of the target device can be more accurately classified.

According to the state classification method of the embodiment, it is possible to grasp a feature including non-linearity of the measurement data which is the time-series data by using the deep learning model 30. Further, according to the state classification method of the embodiment, the deep learning model 30 performs learning for predicting future measurement data, and thus the information of the measurement data can be efficiently compressed and aggregated into the intermediate features h₁ to h_{T}.

According to the state classification method of the embodiment, since the recurrent neural network used for the encoder 31 and the decoder 33 is an LSTM, it is possible to accurately classify the state of the target device using the deep learning model 30 with high prediction accuracy obtained by inputting and learning time-series data having a large data length.

According to the state classification method of the embodiment, by using the deep learning model 30 in which learning is performed such that the cross-correlation among the plurality of elements c^{t}₁ to c^{t}ₙ included in the intermediate feature hₜ is small by orthogonalization, the information of each feature of the measurement data is stored and easily separated in separate elements of the intermediate feature hₜ. By using such intermediate features h₁ to h_{T}, classification and interpretation of the state of the target device becomes easy.

According to the state classification method of the embodiment, the classification performance of the state of the target device is improved by using the deep learning model 30 in which learning is performed using the first time-series data measured for the target device and the second time-series data that simulates the abnormal state of the target device by changing at least one of the phase and the amplitude of the signal component of the specific frequency of the first time-series data. In this case, in the learning of the deep learning model 30, actual data corresponding to the abnormal state of the target device which is difficult to be collected is not required.

According to the state classification method of the embodiment, the classification performance of the state of the target device is improved by using the deep learning model 30 in which learning is performed using the first time-series data and the second time-series data measured before and after the state of the target device changes with time.

The above embodiment and modifications are examples, and the present disclosure is not limited thereto. For example, in the above embodiment, the LSTM is adopted as the neural network, but instead of the LSTM as the neural network, a CNN capable of time-series processing such as a 3D convolutional neural network (3DCNN), a recurrent neural network (RNN) including the LSTM, or a transformer used for language translation may be adopted. In the classification of the state of the target device, for example, when a load coupled to the target device changes or when an operation mode of the target device changes, the state of the target device may be further classified into a plurality of types of states as a normal state. Although the one-class SVM is used as the classifier, other methods may be used, or abnormal data may be learned. For example, abnormality detection may be performed using a k class SVM classified according to the types of abnormality, and the types of abnormality may also be detected. A state change or a degree of the state change may be detected. In this case, for the detection of the state change and the degree of the state change, similar to the abnormality detection, the one-class SVM or the like may be used. The embodiments and the modifications may be combined as appropriate.

The present disclosure includes substantially the same configurations (such as a configuration having the same function, method, and result and a configuration having the same object and effect) as the configurations described in the embodiments. The present disclosure includes a configuration in which a non-essential portion of the configuration described in the embodiments is replaced. The present disclosure may include a configuration capable of achieving the same operation and effect or a configuration capable of achieving the same object as the configuration described in the embodiments. The present disclosure includes a configuration obtained by adding a known technique to the configuration described in the embodiments.

The following contents are derived from the embodiments and modifications described above.

A state classification method according to an aspect includes:
acquiring measurement data of a physical quantity related to vibration measured for a vibrating device;
outputting, by a deep learning model that includes an encoder and a decoder using a recurrent neural network and performs deep learning for predicting a future value of the measurement data for the device, an intermediate feature of the vibration from the encoder based on the measurement data; and
classifying a state of the device using information based on the intermediate feature.

According to the state classification method, since the deep learning model includes the encoder and the decoder using the recurrent neural network, the measurement data can be used for learning as time-series data. That is, it is possible to use the time-series data storing the phase information as it is for learning without converting the measurement data into a frequency spectrum or a spectrogram in which the phase information is missing. Therefore, the intermediate feature output from the encoder of the deep learning model also include the phase information of the vibration of the device. Therefore, according to the state classification method, the state of the device can be more accurately classified by using the information based on the intermediate feature to grasp a phase change of the vibration of the device that cannot be detected by an RMS value of the frequency spectrum or the spectrogram.

According to the state classification method, it is possible to grasp a feature including non-linearity of the measurement data which is the time-series data by using the deep learning model. Further, according to the state classification method, the deep learning model performs learning for predicting future measurement data, and thus the information of the measurement data can be efficiently compressed and aggregated into the intermediate feature.

In the state classification method according to an aspect,
the recurrent neural network may be a long short term memory (LSTM).

According to the state classification method, it is possible to accurately classify the state of the device using the deep learning model with high prediction accuracy obtained by inputting and learning time-series data having a large data length.

In the state classification method according to an aspect,
the deep learning may be learning performed in a direction in which a value of a loss function, the loss function being defined such that orthogonalization proceeds among a plurality of elements included in the intermediate feature, decreases.

According to the state classification method, by using the deep learning model in which learning is performed such that the cross-correlation among the plurality of elements included in the intermediate feature is small, the information of each feature of the measurement data is stored and easily separated in separate elements of the intermediate feature. By using such intermediate feature, classification and interpretation of the state of the device becomes easy.

In the state classification method according to an aspect,
the value of the loss function may decrease as a value of an autocorrelation of the plurality of elements increases, and the value of the loss function may decrease as a value of a cross-correlation of the plurality of elements decreases.

According to the state classification method, it is possible to accurately classify the state of the device using the deep learning model in which learning is performed such that the cross-correlation is small among the plurality of elements included in the intermediate feature.

In the state classification method according to an aspect,
the measurement data may be measurement data of a plurality of channels.

According to the state classification method, since the phase information included in the measurement data is relatively increased, the phase change of the vibration of the device can be easily grasped, and the state of the device can be more accurately classified.

In the state classification method according to an aspect,
the deep learning may be learning performed using first time-series data of the physical quantity measured for the device and second time-series data in which at least one of a phase and an amplitude of a signal component of a specific frequency of the first time-series data is changed.

According to the state classification method, a classification performance of the state of the device is improved by using the deep learning model in which learning is performed using the time-series data simulating an abnormal state of the device. In the learning of the deep learning model, actual data corresponding to the abnormal state of the device which is difficult to be collected is not required.

In the state classification method according to an aspect,
the deep learning may be learning performed using first time-series data of the physical quantity measured for the device and second time-series data of the physical quantity measured for the device whose state changes with time after the first time-series data is measured.

According to the state classification method, the classification performance of the state of the device is improved by using the deep learning model in which learning is performed using the time-series data before and after the state of the device changes with time.

A state classification device according to an aspect includes:
a measurement data acquisition unit configured to acquire measurement data of a physical quantity related to vibration measured for a vibrating device;
an intermediate feature output unit configured to output, by a deep learning model that includes an encoder and a decoder using a recurrent neural network and performs deep learning for predicting a future value of the measurement data for the device, an intermediate feature of the vibration from the encoder based on the measurement data; and
a state classification unit configured to classify a state of the device using information based on the intermediate feature.

According to the state classification device, the state of the device can be more accurately classified by using the information based on the intermediate feature including phase information of the vibration of the device to grasp a phase change of the vibration of the device that cannot be detected by an RMS value of a frequency spectrum or a spectrogram.

A state classification program according to an aspect causing a computer to:
acquire measurement data of a physical quantity related to vibration measured for a vibrating device;
output, by a deep learning model that includes an encoder and a decoder using a recurrent neural network and performs deep learning for predicting a future value of the measurement data for the device, an intermediate feature of the vibration from the encoder based on the measurement data; and
classify a state of the device using information based on the intermediate feature.

According to the state classification program, the state of the device can be more accurately classified by using the information based on the intermediate feature including phase information of the vibration of the device to grasp a phase change of the vibration of the device that cannot be detected by an RMS value of a frequency spectrum or a spectrogram.

What is claimed is:

1. A state classification method comprising:
acquiring measurement data of a physical quantity related to vibration measured for a vibrating device;
outputting, by a deep learning model that includes an encoder and a decoder using a recurrent neural network and performs deep learning for predicting a future value of the measurement data for the device, an intermediate feature of the vibration from the encoder based on the measurement data; and
classifying a state of the device using information based on the intermediate feature.

2. The state classification method according to claim 1, wherein
the recurrent neural network is a long short term memory (LSTM).

3. The state classification method according to claim 1, wherein
the deep learning is learning performed in a direction in which a value of a loss function, the loss function being defined such that orthogonalization proceeds among a plurality of elements included in the intermediate feature, decreases.

4. The state classification method according to claim 3, wherein
the value of the loss function decreases as a value of an autocorrelation of the plurality of elements increases, and the value of the loss function decreases as a value of a cross-correlation of the plurality of elements decreases.

5. The state classification method according to claim 1, wherein
the measurement data is measurement data of a plurality of channels.

6. The state classification method according to claim 1, wherein
the deep learning is learning performed using first time-series data of the physical quantity measured for the device and second time-series data in which at least one of a phase and an amplitude of a signal component of a specific frequency of the first time-series data is changed.

7. The state classification method according to claim 1, wherein
the deep learning is learning performed using first time-series data of the physical quantity measured for the device and second time-series data of the physical quantity measured for the device whose state changes with time after the first time-series data is measured.

8. A state classification device comprising:
a measurement data acquisition unit configured to acquire measurement data of a physical quantity related to vibration measured for a vibrating device;
an intermediate feature output unit configured to output, by a deep learning model that includes an encoder and a decoder using a recurrent neural network and performs deep learning for predicting a future value of the measurement data for the device, an intermediate feature of the vibration from the encoder based on the measurement data; and
a state classification unit configured to classify a state of the device using information based on the intermediate feature.

9. A non-transitory computer-readable storage medium storing a state classification program, the program causing a computer to:
acquire measurement data of a physical quantity related to vibration measured for a vibrating device;
output, by a deep learning model that includes an encoder and a decoder using a recurrent neural network and performs deep learning for predicting a future value of the measurement data for the device, an intermediate feature of the vibration from the encoder based on the measurement data; and
classify a state of the device using information based on the intermediate feature.
